(19) United States
(12) Patent Application Publication
(10) Pub. No.: US 2011/0113268 A1
(43) Pub. Date: May 12, 2011

(54) COMMUNICATION DEVICE

(75) Inventor: Ken Matsushita, Tokyo (JP)

(73) Assignee: KABUSHIKI KAISHA TOSHIBA, Tokyo (JP)

(21) Appl. No.: 12/891,580

(22) Filed: Sep. 27, 2010

(30) Foreign Application Priority Data
Nov. 11, 2009 (JP) 2009-258268

(51) Int. Cl. G06F 1/26

(52) U.S. Cl. 713/310

(57) ABSTRACT

In one embodiment, a communication device includes: a relay module relaying communication of a signal between devices; a notification module giving a notice to recover from a standby state to the device via different communication from the communication; a function judgment module referring to information indicating a function of the device in the signal from the device to judge whether the device is to be recovered by the notice; a signal proxy response module sending a response indicating of receiving the signal as a proxy to the device from which the signal is transmitted when the signal indicates an instruction to recover, and the device to which the signal is transmitted is judged to recover by the notice; and a notification control module instructing the notification module to give the notice to the device to which the signal is transmitted and for which the proxy response is sent.

### CROSS-REFERENCE TO RELATED APPLICATIONS

This application is based upon and claims the benefit of priority from Japanese Patent Application No. 2009-258268, filed Nov. 11, 2009, the entire contents of which are incorporated herein by reference.

### FIELD

Embodiments described herein relate generally to a communication device.

### BACKGROUND

Conventionally, in devices such as household electrical appliances, control signals are transmitted to each other via communication interfaces such as the HDMI (High-Definition Multimedia Interfaces) so that a coupled operation of the devices is realized. As a communication device that relays the communication between the devices, for example, an AV amplifier or a selector that relays the HDMI communication has been known. In order to handle the device in a standby state in which the power is off, if communication is transmitted to the device in the standby state, a conventional communication device sends a recovery request from the standby state to the device to which the communication is transmitted, and sends a proxy response to the device from which the communication is transmitted (see Japanese Patent Application Publication (KOKAI) No. 2004-126959).

Recently, the power saving performance of a device has been increased. In order to further reduce the standby power consumption of the device in a standby state where a power supply can be turned on by a signal from the outside as a trigger, the device causes the communication interface such as the HDMI not to be at work in the standby state, and turns on the main power supply of the entire device by a notice from a remote controller as the trigger via wireless or infrared communication to recover from the standby state. Thus, regarding the device that causes the communication interface such as the HDMI not to be at work in the standby state, even if the recovery request from the standby state is sent to the device via the communication interface, the device cannot recover from the standby state. Therefore, according to the above-mentioned communication device, if the communication interfaces of the communication device to relay the communication are connected to both the device that is not at work in the standby state and the device that is at work in the standby state, it can be impossible to realize the coupled operation of the devices.

### BRIEF DESCRIPTION OF THE SEVERAL VIEWS OF THE DRAWINGS

FIG. 1 is an exemplary block diagram of a system using a communication device according to an embodiment;

FIG. 2 is an exemplary block diagram of the communication device in the embodiment;

FIG. 3 is an exemplary table of contents of data stored in a connection device information memory in the embodiment; and

FIG. 4 is an exemplary ladder chart illustrating operations of the system using the communication device in the embodiment.

### DETAILED DESCRIPTION

In general, according to one embodiment, a communication device includes: a relay module connected to each of a plurality of devices and configured to relay communication of signals including a control signal between the devices; a notification module configured to give a notice to recover from a standby state to one of the devices via communication different from the communication used by the relay module; a function judgment module configured to refer to information indicating a function of each of the devices included in the control signal transmitted from the corresponding device to judge whether the corresponding device is to be recovered from the standby state by the notice from the notification module; a control signal proxy response module configured to send a response indicating of receiving the control signal relayed by the relay module as a proxy to the device from which the control signal is transmitted when the control signal indicates an instruction to recover from the standby state, and the device to which the control signal is transmitted is judged by the function judgment module to recover from the standby state by the notice from the notification module; and a notification control module configured to instruct the notification module to give the notice to recover from the standby state to the device to which the control signal is transmitted and for which the proxy response is sent.

In one embodiment, a communication device will now be explained in detail with reference to the drawings.

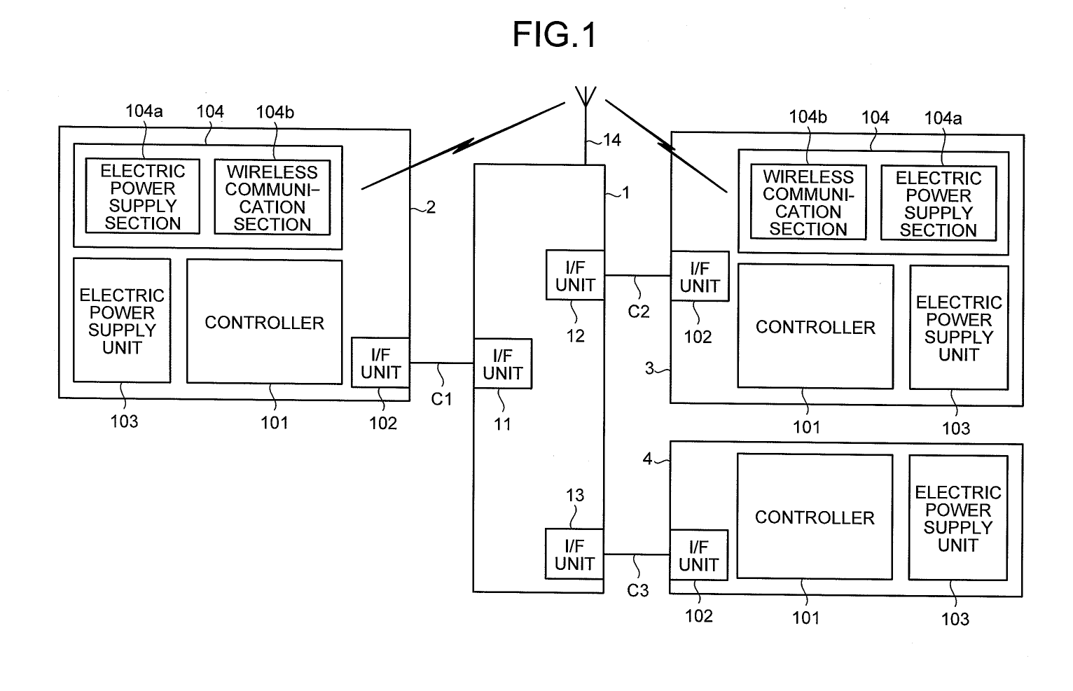

FIG. 1 is an exemplary block diagram of a system using a communication device 1 according to an embodiment. As illustrated in FIG. 1, the communication device 1 relays communication between devices 2, 3, 4 connected to each other at interface (I/F) units 11, 12, 13 via communication cables such as HDMI cables C1, C2, C3.

The I/F units 11, 12, 13 include the HDMI terminals that meet the HDMI standard and so on to connect to the communication cables C1, C2, C3, respectively, and transmit/receive a control signal such as HDMI-CEC (HDMI-Consumer Electronics Control) command (hereinafter referred to as CEC command) in addition to multimedia data such as video data or audio data.

When the communication device 1 receives multimedia data or a CEC command through one of the I/F units 11, 12, 13, the communication device 1 outputs the input data from another of the I/F units 11, 12, 13 to relay the communication between the devices connected to the communication device 1. Specifically, the communication device 1 can be an AV amplifier, a selector and so on to relay the HDMI communication. In the system exemplarily illustrated in FIG. 1, the communication complying with the HDMI standard between the devices 2, 3, 4 is relayed by the communication device 1. A wireless communication unit 14 includes a communication antenna, a transmitting/receiving circuit and so on to communicate with a minimum electric power standby function unit 104 described below.

The devices 2, 3, 4 can be, for example, a display device such as a television, a reproduction device such as a DVD (Digital Versatile Disc) player, or a recording and reproducing device to record and reproduce data on and from a high-capacity recording medium such as a HDD (Hard Disk Drive), and transmit/receive the multimedia data and the CEC command via the communication cables C1, C2, C3, respectively. Each of the devices 2, 3 includes a controller 101, an I/F unit 102, an electric power supply unit 103, the minimum electric power standby function unit 104 and so on. The device 4 includes the controller 101, the I/F unit 102, the electric power supply unit 103 and so on.

The controller 101 includes a microcontroller, a CPU (Central Processing Unit), a RAM (Random Access Memory), a ROM (Read Only Memory) and so on, and centrally controls operations of the device. For example, the CPU loads various programs stored in the ROM into a work area of the RAM to execute them in sequence, and outputs a control signal to each section within the device to integrally control an operation of each section. In the ROM and the RAM of the controller 101, information indicating function, setting, and status of the corresponding device is stored. When the CEC command of a search request for the function, the setting, and the status of the device is received, the controller 101 reads the information from the ROM and the RAM to respond with the CEC command.

Like the I/F units 11, 12, 13, the I/F unit 102 includes the HDML terminal that meets the HDMI standard and so on. Under the control of the controller 101, the I/F unit 102 transmits/receives the CEC command in addition to the multimedia data. The electric power supply unit 103 is a power supply circuit that supplies each section with electric power supplied from a commercial power supply and so on when power is turned ON by a power supply switch (not illustrated) or the minimum electric power standby function unit 104.

The minimum electric power standby function unit 104 is an IC(Integrated Circuit) chip and so on having relay function to turn on a main power supply of the electric power supply unit 103 when the minimum electric power standby function unit 104 receives a notice as a trigger from a remote controller (not illustrated) and so on via wireless communication. Specifically, the minimum electric power standby function unit 104 includes an electric power supply section 104a, and a wireless communication section 104b.

The electric power supply section 104a includes a capacitor and so on for storing therein electric power supplied from the electric power supply unit 103, and supplies electric power to drive the minimum electric power standby function unit 104 not only when power is on but also in a standby state that no electric power is supplied from the electric power supply unit 103. The wireless communication section 104b includes an antenna for transmitting/receiving a radio signal, a transmitting/receiving circuit, a relay circuit and so on.

Thus, because each of the devices 2, 3 includes the minimum electric power standby function unit 104, each of the devices 2, 3 can turn on the main power supply in the standby state by a trigger notified from the remote controller and so on via the communication different from the communication that meets the HDMI standard through the I/F units 11, 12, 13 and so on without supplying electric power to each section using the commercial electric power by the electric power supply unit 103.

As mentioned above, the standby state that the main power supply can be turned on by the notification as the trigger from the remote controller and so on without supplying electric power to each section using the commercial power supply by the electric power supply unit 103 is referred to as the minimum electric power standby. Each of the devices 2, 3 is adaptable to the minimum electric power standby, and the device 4 is not adaptable to the minimum electric power standby.

In the device 4 that is not adaptable to the minimum electric power standby, the electric power supply unit 103 supplies electric power to the I/F unit 102 in the standby state. The device 4 returns from the standby state when the device 4 receives the notification as the trigger transmitted via the HDMI communication. On the other hand, in each of the devices that are adaptable to the minimum electric power standby, because any units other than the minimum electric power standby function unit 104 do not operate, each of the devices cannot return from the standby state by any notification as a trigger transmitted via the HDMI communication.

The wireless communication performed by the wireless communication section 104b can be any communication different from communication (for example, the HDML communication) used for relaying between the devices connected to the I/F units 11, 12, 13 and so on. For example, Bluetooth (registered trademark) and a wireless LAN (Local Area Network) can be used. In the embodiment, the minimum electric power standby function unit 104 that turns on the main power supply by the notification as the trigger via the wireless communication is exemplarily described. In order to transmit/receive the notification as the trigger for turning on the main power supply, not only the wireless communication, but also infrared communication can be used.

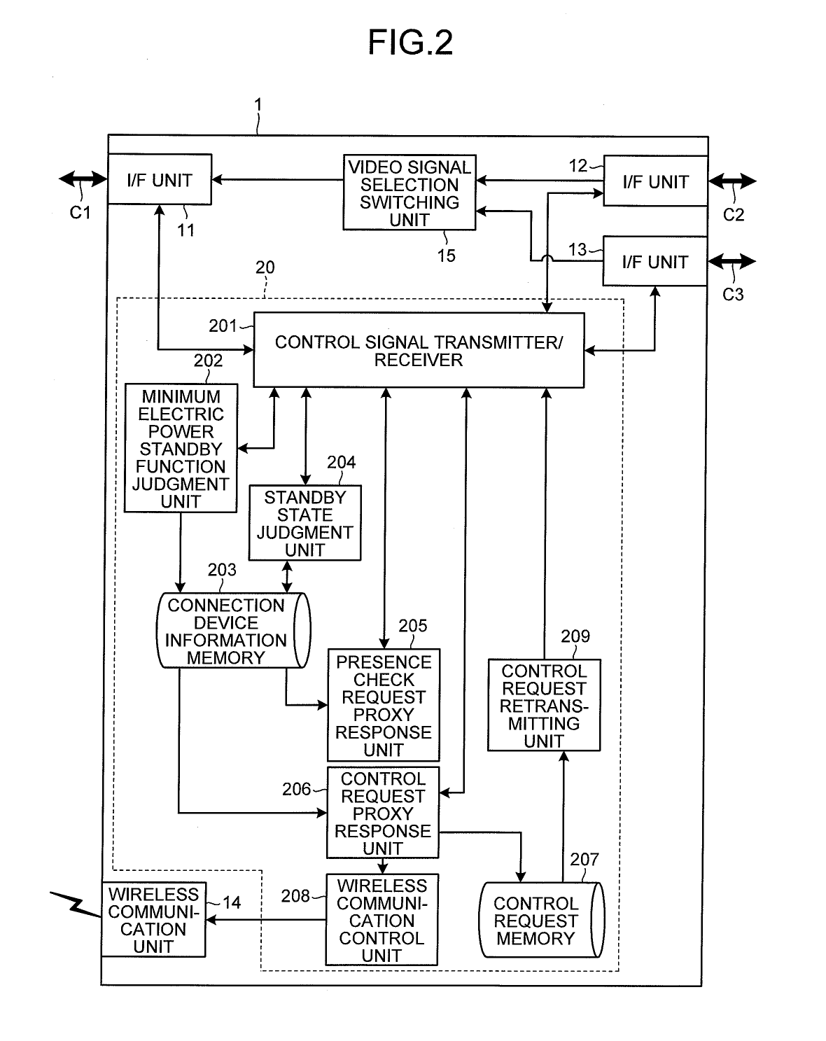

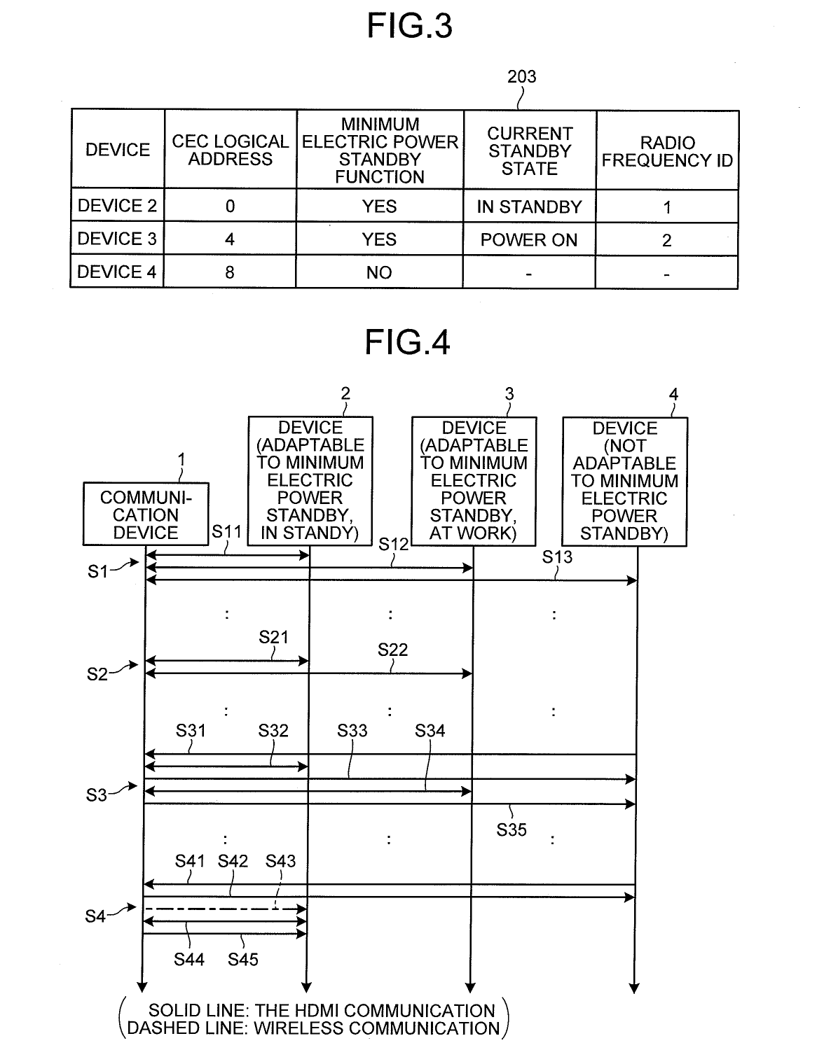

FIG. 2 is an exemplary block diagram of the communication device 1 according to the embodiment. FIG. 3 is an exemplary table of contents of data stored in a connection device information memory 203 according to the embodiment. FIG. 4 is an exemplary ladder chart illustrating operations of the system using the communication device 1 according to the embodiment.

As illustrated in FIG. 2, the communication device 1 includes a video signal selection switching unit 15, and a communication control unit 20 in addition to the I/F units 11, 12, 13, and the wireless communication unit 14.

The video signal selection switching unit 15 selects one of the I/F units 12, 13, and outputs a video signal included in the signal input from the selected I/F unit to the I/F unit 11. In the video signal selection switching unit 15, the selection of the video signal to be output to the I/F unit 11 can be performed based on a switching instruction by a select switch (not illustrated), the presence or absence of input of the video signal from the I/F unit 12 or the I/F unit 13, or the CEC command, etc. In the communication device 1, for example, if the display device is connected to the I/F unit 11, and the reproduction device and the recording and reproducing device are connected to the I/F units 12, 13, the outputs of the reproduction device and the recording and reproducing device can be switched to be displayed on the display device.

The communication control unit 20 includes a microcomputer, a CPU, a RAM, a ROM, and so on, and controls communication performed by the communication device 1. Specifically, the communication control unit 20 includes a control signal transmitter/receiver 201, a minimum electric power standby function judgment unit 202, the connection device information memory 203, a standby state judgment unit 204, a presence check request proxy response unit 205, a control request proxy response unit 206, a control request memory 207, a wireless communication control unit 208, a control request retransmitting unit 209.

The control signal transmitter/receiver 201 transmits/receives the CEC command (control signal) at the I/F units 11, 12, 13. For example, if the CEC command is input from one of the I/F units 11, 12, 13, the control signal transmitter/receiver 201 outputs the CEC command from another of the I/F units 11, 12, 13 to relay the CEC command. On responding as a proxy described later, the control signal transmitter/receiver 201 responds to the input CEC command.

The minimum electric power standby function judgment unit 202 instructs the control signal transmitter/receiver 201 to transmit the CEC command for search to each of the devices connected to the I/F units 11, 12, 13. The minimum electric power standby function judgment unit 202 analyses each of the responses to the CEC commands for search from the devices connected to the I/F units 11, 12, 13 to judge whether each of the devices is adaptable to the minimum electric power standby. The judgment results by the minimum electric power standby function judgment unit 202 are stored in the connection device information memory 203.

Specifically, as illustrated in S1 of FIG. 4, the communication device 1 transmits the CEC commands for search to the devices 2, 3, 4 connected to the communication device 1, and receives the responses from the devices 2, 3, 4 to judge whether the devices 2, 3, 4 are adaptable to the minimum electric power standby (S11, S12, S13). The operations illustrated in S1 are performed when the communication device 1 is turned on, and at predetermined intervals counted by a timer (not illustrated) such as an RTC (Real Time Clock) arranged in the communication device 1.

The CEC command for search is predetermined as a vendor command and so on to search a function and a setting of the connected device. For example, in case of searching whether the device is adaptable to the minimum electric power standby, the CEC command in which a flag indicating the minimum electric power standby function is set is transmitted to judge the presence or absence of the flag in the CEC command in response. Thus, it is possible to judge whether the device is adaptable to the minimum electric power standby.

The device adaptable to HDMI-CEC has the CEC logical address of 4 bits. Therefore, the minimum electric power standby function judgment unit 202 instructs the control signal transmitter/receiver 201 to transmit the CEC command to all of addresses of 0 to 14 except values indicating broadcasting to search whether a device that is using the CEC logical address is present or not, and if it is present, the device is adaptable to the minimum electric power standby or not.

By using the CEC command for inquiry and so on like the CEC command for search with respect to each of the devices judged to be adaptable to the minimum electric power standby, the minimum electric power standby function judgment unit 202 searches a radio frequency ID which is uniquely allocated to the minimum electric power standby function unit 104 and can be designated when the transition from the minimum electric power standby state to the power supply on state, using the received signal as the trigger is performed. As mentioned above, the communication device 1 obtains the information regarding each of the devices connected to the communication device 1 by using the minimum electric power standby function judgment unit 202.

As illustrated in FIG. 3, the judgment results and the searched results of the minimum electric power standby function judgment unit 202 are stored in the connection device information memory 203. In FIG. 3, the item of DEVICE is added to data stored in the connection device information memory 203 in order to exemplarily indicate correspondence relations between the devices 2, 3, 4 exemplarily illustrated in FIG. 1 and the CEC logical addresses. Thus, items actually stored in the connection device information memory 203 are the CEC logical address, the minimum electric power standby function, a current standby state, the radio frequency ID, and so on.

In an example of FIG. 3, information stored in the connection device information memory 203 is following: the device 2 whose CEC logical address is 0, the device 3 whose CEC logical address is 4, and the device 4 whose CEC logical address is 8 are connected to the communication device 1, the devices 2, 3 are adaptable to the minimum electric power standby, and the device 4 is not adaptable to the minimum electric power standby.

The standby state judgment unit 204 refers to data stored in the connection device information memory 203 at regular intervals counted by the timer to check whether each of the devices which are adaptable to the minimum electric power standby and are connected to the communication device 1 is in the standby state. The standby state judgment unit 204 stores the checked results in the connection device information memory 203. The check whether each of the devices are in the standby state is performed based on the presence or absence of the response to the polling of the CEC command when the control signal transmitter/receiver 201 performs the polling of the CEC command with respect to each of the devices adaptable to the minimum electric power standby.

As mentioned above, because the device in the minimum electric power standby cannot respond to the CEC command, if the CEC logical address is stored in the connection device information memory 203 and the device does not respond to the polling of the CEC command, the device is checked to be in the standby state.

As exemplarily illustrated in FIG. 3, the CEC logical addresses of the devices 2, 3 adaptable to the minimum electric power function are stored in the connection device information memory 203. Thus, as illustrated in S2 of FIG. 4, the communication device 1 performs the polling of the CEC command with respect to each of the devices 2, 3 to check whether each of the devices 2, 3 is in the standby state (S21, S22). The checked results are stored in the current standby state of the connection device information memory 203. As mentioned above, the communication device 1 monitors whether each of the devices which are connected to the communication device 1 and which are adaptable to the minimum electric power standby is currently in the standby state.

When the presence check request proxy response unit 205 receives the CEC command for presence check request to the device in the minimum electric power standby at the control signal transmitter/receiver 201, the presence check request proxy response unit 205 instructs the control signal transmitter/receiver 201 to respond as a proxy to the CEC command for presence check request. The CEC command for presence check request is a check request instruction to request a response to check the presence of a first device, which is sent from a second device to the first device of the devices connected to the communication device 1. The polling of the CEC command for presence check request is performed with respect to the first device.

The presence check request proxy response unit 205 always monitors the CEC command transmitted between the devices at the control signal transmitter/receiver 201, and checks the CEC logical address of the device to which the command is sent if the command is the CEC command for presence check request. Further, the presence check request proxy response unit 205 refers to the connection device information memory 203 to judge whether the device to which the CEC command is sent is adaptable to the minimum electric power standby, and is currently in the standby state. As the result of the judgment, if the device is in the standby state, the presence check request proxy response unit 205 instructs the control signal transmitter/receiver 201 to respond as the proxy instead of the device which cannot respond.

The device uses the CEC command for presence check request in order to check whether another device in use is present and to prevent a collision of the CEC logical address by allocating and using the CEC logical address other than the CEC logical address in use. The device receives a response to the CEC command for presence check request to check the presence of the device corresponding to the CEC logical address of the response. The device transmits the CEC command for control request and so on to the device whose presence is checked. Thus, if the device in the minimum electric power standby cannot respond to the CEC command for presence check request, the presence of the device may not be recognized by another of the devices.

When the control signal transmitter/receiver 201 receives the CEC command for presence check request to the device in the minimum electric power standby, the presence check request proxy response unit 205 instructs the control signal transmitter/receiver 201 to respond as the proxy. Thus, even if the device to which the CEC command is transmitted is in the minimum electric power standby, it is possible to cause the device from which the CEC command is transmitted to recognize the presence of the device to which the CEC command is transmitted.

As exemplarily illustrated in FIG. 3, for example, the information indicating that the device 2 is currently in the standby state is stored in the connection device information memory 203. Therefore, as illustrated in S3 of FIG. 4, when the device 4 transmits the CEC command for presence check request to the device 2 connected to the device 4 via the communication device 1 to check the presence of the device 2 (S31, S32), the communication device 1 responds to the device 4 as the proxy instead of the device 2 that is currently in the standby state (S33) . When the device 4 transmits the CEC command for presence check request to the device 3 to check the presence of the device 3 (S31, S34), the device 3 normally responds to the device 4 without the response as the proxy (S35).

When the control request proxy response unit 206 receives the CEC command for control request to the device in the minimum electric power standby at the control signal transmitter/receiver 201, the control request proxy response unit 206 instructs the control signal transmitter/receiver 201 to respond as a proxy to the CEC command for control request. The CEC command for control request can be an instruction to turn on /off the main power supply, an instruction to start/end a reproduction, an instruction to start/end a display, an instruction to switch the video signal selection switching unit 15 in the communication device 1, and so on.

The control request proxy response unit 206 always monitors the CEC command transmitted between the devices at the control signal transmitter/receiver 201, and if the CEC command is the CEC command for control request, the control request proxy response unit 206 checks the CEC logical address of which the CEC command is transmitted to. Further, by referring to the connection device information memory 203, the control request proxy response unit 206 judges whether the device to which the CEC command for control request is transmitted is adaptable to the minimum electric power standby and is currently in the standby state. As the result of the judgment, if the device is in the standby state, the control request proxy response unit 206 instructs the control signal transmitter/receiver 201 to perform the acknowledgement as the proxy instead of the device that cannot respond.

As exemplarily illustrated in FIG. 3, the information indicating that the device 2 is currently in the standby state is stored in the connection device information memory 203. Therefore, as illustrated in S4 of FIG. 4, when the device 4 transmits the CEC command for control request to the device 2 connected to the device 4 via the communication device 1 (S41), the communication device 1 responds to the device 4 as the proxy instead of the device 2 that is currently in the standby state (S42).

As mentioned above, when the control signal transmitter/receiver 201 receives the CEC command for control request to the device in the minimum electric power standby, the control request proxy response unit 206 instructs the control signal transmitter/receiver 201 to perform the acknowledgement as the proxy to cause the device from which the CEC command is transmitted to recognize that the CEC command is received even if the device to which the CEC command is transmitted is in the minimum electric power standby and cannot respond to and process the CEC command right away.

However, at this timing, only the responding as the proxy to the CEC command for control request is performed, and the CEC command for control request is not received by the device in the minimum electric power standby. Therefore, the control request proxy response unit 206 analyses the content of the CEC command for control request to judge whether turning on the main power supply in the device in the minimum electric power standby is only needed, or any other control is also needed in the state that the main power supply is turned on. If any other control is also needed in the state that the main power supply is turned on, the control request proxy response unit 206 causes the control request memory 207 to store the received CEC command for control request.

Until the device in the minimum electric power standby recovers from the standby state, the CEC commands for control request received regarding the device are stacked in the control request memory 207 in order. After the device recovers from the standby state, the CEC commands for control request stacked in order in the control request memory 207 are read in order to be retransmitted by the control request retransmitting unit 209 described below.

The wireless communication control unit 208 controls wireless communication at the wireless communication unit 14. Specifically, the wireless communication control unit 208 instructs the wireless communication unit 14 to give a notice to turn on the main power supply to the device in the minimum electric power standby for which the control request proxy response unit 206 performed the acknowledgement as the proxy. For example, as illustrated in S4 of FIG. 4, when the communication device 1 performs the acknowledgement to the device 4 instead of the device 2 that is currently in the standby state (S42), the communication device 1 gives the notice to turn on the main power supply to the device 2 for which the acknowledgement is performed via wireless communication (S43). Thus, the device 2 recovers from the standby state.

When the control request proxy response unit 206 performs the acknowledgement as the proxy for the device in the minimum electric power standby, the control request proxy response unit 206 reads the radio frequency ID of the device in the minimum electric power standby from the connection device information memory 203 to transmit to the wireless communication control unit 208. The wireless communication control unit 208 instructs the wireless communication unit 14 to gives the notice to turn on the main power supply to the device of the radio frequency ID transmitted by the control request proxy response unit 206 to turn on the main power supply of only the device for which the control request proxy response unit 206 performed the acknowledgement as the proxy.

By causing the wireless communication control unit 208 to give the notice to turn on the main power supply to all the devices in the minimum electric power standby with using a broadcast transmission by the wireless communication unit 14, a configuration to turn on the main power supplies of all the devices connected to the communication device 1 can be implemented.

The control request retransmitting unit 209 instructs the control signal transmitter/receiver 201 to retransmit the CEC command for control request to the device in the minimum electric power standby for which the control request proxy response unit 206 performed the acknowledgement as the proxy, after the device recovers from the standby state.

Specifically, as illustrated in S4 of FIG. 4, after the wireless communication control unit 208 instructs the wireless communication unit 14 to give the notice to turn on the main power supply to the device, the control request retransmitting unit 209 instructs the control signal transmitter/receiver 201 to transmit the CEC command to the device to which the notice is given at predetermined intervals to wait for a response to the transmitted CEO command (S44). After recognizing that the device has recovered from the standby state by detecting the response, the control request retransmitting unit 209 reads the CEC command for control request stored in the control request memory 207 to retransmit to the device that has recovered from the standby state if any other control is needed in the state that the main power supply is turned on (S45).

By those processes, for example, the device 4 can perform an additional control such as the control to start the reproduction and the display for the device 2 after the device 2 recovers from the standby state, in addition to the control to turn on the main power supply to cause the device 2 in the minimum electric power standby to recover from the standby state.

As mentioned above, the communication device 1 is connected to the plurality of devices via the I/F unit 11, 12, 13, respectively, and relays the communication of the signals including the control signal between the devices, and gives a notice to cause one of the devices to recover from the standby state to the one of the devices with the wireless communication unit 14 performing the communication different from the communication to be relayed. The minimum electric power standby function judgment unit 202 refers to the information indicating the function of the device included in the control signal to judge whether the device is to be caused to recover from the standby state by the notice from the wireless communication unit 14. When the detected control signal indicates the instruction to recover from the standby state, and the device to which the control signal is transmitted is judged to recover from the standby state by the notice from the wireless communication unit 14, the control request proxy response unit 206 instructs the control signal transmitter/receiver 201 to send the response indicating of receiving the control signal as the proxy to the device from which the control signal is transmitted. The wireless communication control unit 208 instructs the wireless communication unit 14 to give the notice for the recovery from the standby state to the device to which the control signal is transmitted and for which the proxy response is sent.

Therefore, even if the communication interfaces of the communication device 1 to relay the communication are connected to both the devices 2, 3 that are not at work in the standby state and the device 4 that is at work in the standby state, it is possible to realize a coupled operation of the devices.

In the embodiment, the case that the communication that meets the HDMI standard is performed in the communication interfaces is exemplarily described. However, the communication interfaces are not limited to the HDMI, but can be any other communication interface having a control command system like the HDMI-CEC command and so on. For example, the communication device 1 may relay the communication between the devices 2, 3, 4 with LAN. In case of using LAN, it is possible to perform the control such as turning on the power supply by using not the CEC command but the Wakeup on LAN command and so on as the control command with the Wakeup on LAN function and the HDMI 1.4—defined HEC and so on.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication device comprising:
a relay module connected to each of a plurality of devices and configured to relay communication of signals including a control signal between the devices;
a notification module configured to send a notice to recover from a standby state to one of the devices via communication different from the communication used by the relay module;
a function determining module configured to refer to information indicating a function of each of the devices included in the control signal transmitted from the corresponding device to determine whether the corresponding device is to be recovered from the standby state by the notice from the notification module;
a control signal proxy response module configured to send a proxy response indicating receipt of the control signal relayed by the relay module to the device from which the control signal is transmitted when the control signal indicates an instruction to recover from the standby state, and the device to which the control signal is transmitted is determined by the function judgment module to recover from the standby state by the notice from the notification module; and
a notification control module configured to instruct the notification module to send the notice to recover from the standby state to the device to which the control signal is transmitted and for which the proxy response is sent.

2. The communication device of claim 1, further comprising:
a state determining module configured to refer to the information indicating the function of each of the devices included in the control signal transmitted from the corresponding device to determine whether the corresponding device determined by the function determining module to be recovered from the standby state by the notice from the notification module is in the standby state,
wherein the control signal proxy response module is configured to send the proxy response when the device determined by the function determining module to be recovered from the standby state by the notice from the notification module is determined by the state determination module to be in the standby state.

3. The communication device of claim 2, further comprising:
a check request proxy response module configured to send to the device from which the control signal is transmitted a response as a proxy to a check request instruction to request a response to check a presence of the device to which the check request instruction is transmitted when the control signal relayed by the relay module is the check request instruction and the device to which the check request instruction is transmitted is determined by the state determination module to be in the standby state.

4. The communication device of claim 1, further comprising:
a memory configured to store therein the control signal transmitted to the device to which the notice to recover from the standby state is given by the notification control module until the device to which the notice is given recovers from the standby state; and
a retransmitter configured to retransmit the control signal stored in the memory to the device to which the notice is given after the device to which the notice is given recovers from the standby state.

5. The communication device of claim 1, wherein the communication relayed by the relay module is High-Definition Multimedia Interface (HDMI) communication, and the control signal is a HDMI-Consumer Electronics Control signal.

6. The communication device of claim 5, wherein the communication used by the notification module which is different from the communication used by the relay module is one of wireless communication and infrared communication.
